(19) United States
(12) Patent Application Publication
(10) Pub. No.: US 2009/0288282 A1
(43) Pub. Date: Nov. 26, 2009

(54) Method of Making a Golf Club Head

(75) Inventors: Hsiao-Wen Chao, Ping-Tung Hsien (TW); Yu-Zheng Huang, Ping-Tung Hsien (TW); Tien-Lung Tang, Ping-Tung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: O-TA PRECISION INDUSTRY CO. LTD., Ping-Tung Hsien (TW)

(21) Appl. No.: 12/239,455

(22) Filed: Sep. 26, 2008

(30) Foreign Application Priority Data
May 26, 2008 (TW) 097119352

(51) Int. Cl. B23P 11/00; A63B 53/04

(52) U.S. Cl. 29/428; 473/324

(57) ABSTRACT

A method of making a golf club head includes the steps of: preparing a head body formed with at least one cavity, and at least one flange protruding from the head body and proximate to the cavity; mounting a counterweight unit in the cavity; bending the flange toward the cavity and pressing the flange against the counterweight unit; joining the counterweight unit to the head body using a solder; and polishing the head body and the counterweight unit to remove excess of the flange and the solder.

### BACKGROUND OF THE INVENTION

1. Field of the Invention

The invention relates to a method of making a golf club head, more particularly to a method of making a golf club head having an improvement in joining a counterweight unit to a head body.

2. Description of the Related Art

Referring to FIG. 1, a conventional method of making a golf club head includes the steps of: preparing a head body 11 including a striking portion 111, and a rear portion 112 opposite to the striking portion 111 and formed with one or more cavities 113 (two cavities 113 are illustrated in FIG. 1); applying a solder into the cavities 113; mounting two counterweight units 12 in the cavities 113, respectively; pressing the counterweight units 12 in the cavities 113 using a fixture device 13; and joining the counterweight units 12 to the head body 11 via hard-soldering.

Since the profile of a head body and the number and position of cavities vary according to the specific weight-distribution requirement for a golf club head to be made, it is required to design a specific fixture for joining one or more counterweight units to a head body to make a golf club head having a specific weight-distribution requirement. Therefore, the conventional method of making a golf club head is relatively complicated, inefficient, and cost-wasting.

### SUMMARY OF THE INVENTION

Therefore, an object of the present invention is to provide a method of making a golf club head, which is improved in a manner of joining a counterweight unit to a head body.

Accordingly, the method of making a golf club head of this invention includes the steps of: preparing a head body formed with at least one cavity, and at least one flange protruding from the head body and proximate to the cavity; mounting a counterweight unit in the cavity; bending the flange toward the cavity and pressing the flange against the counterweight unit; joining the counterweight unit to the head body using a solder; and polishing the head body and the counterweight unit to remove excess of the flange and the solder.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view illustrating a conventional method of making a golf club head;

FIG. 2 is a flow chart of a preferred embodiment of a method of making a golf club head according to this invention; and

FIGS. 3 to 7 are perspective views illustrating consecutive steps of the preferred embodiment.

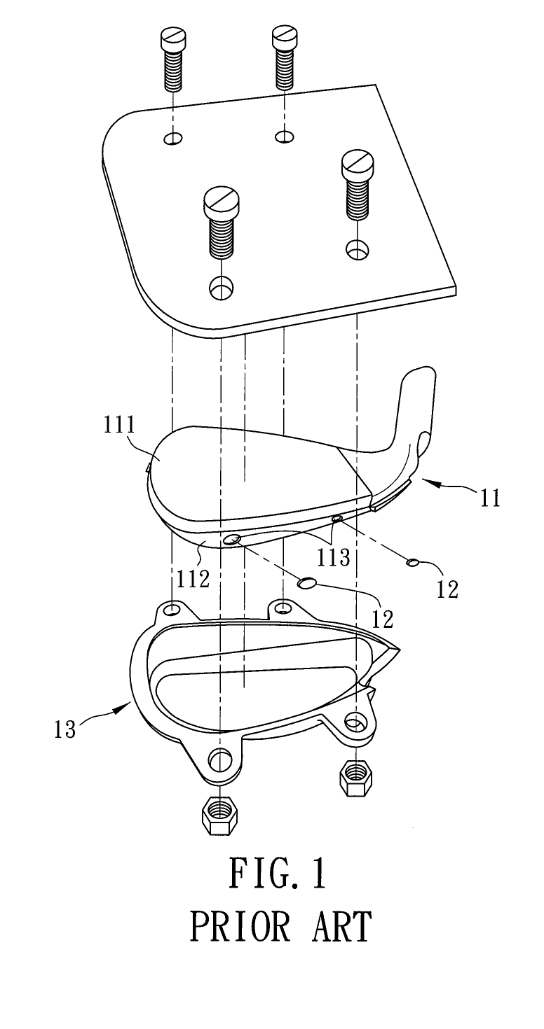

### DETAILED DESCRIPTION OF THE PREFERRED EMBODIMENT

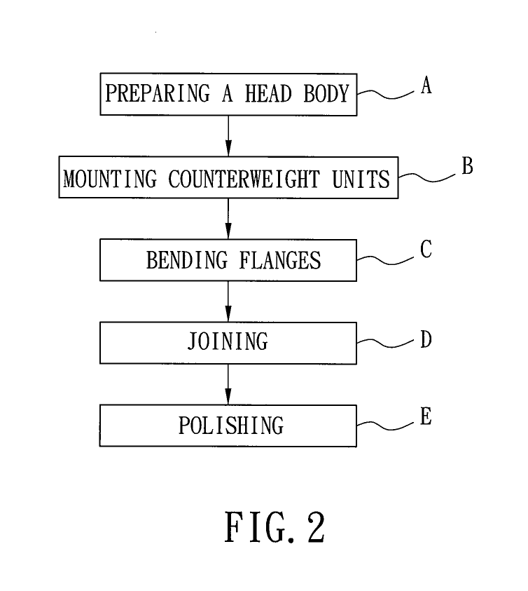

Referring to FIG. 2, the preferred embodiment of a method of making a golf club head according to this invention is shown to include the steps of:

A) Preparing a Head Body:

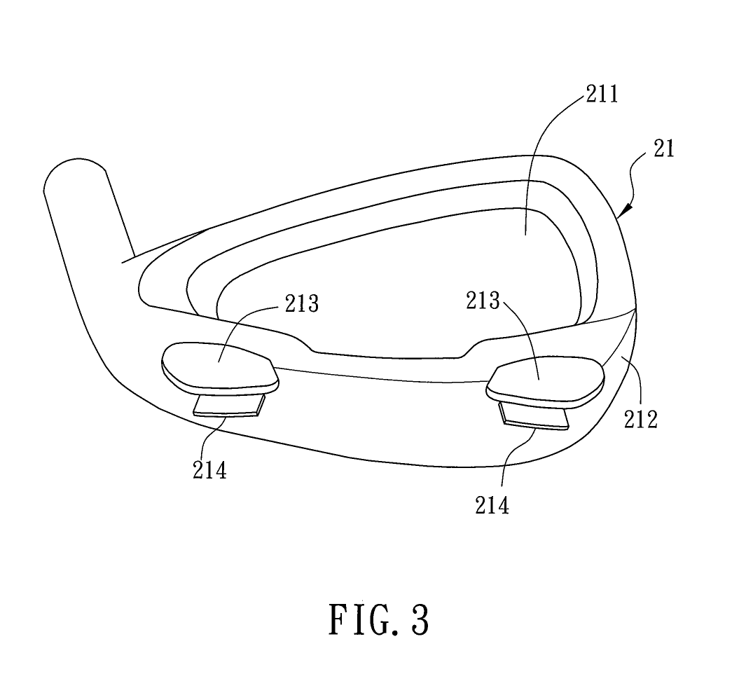

Referring to FIG. 3, a head body 21 is prepared, which includes a striking portion 211, and a rear portion 212 opposite to the striking portion 211. The rear portion 212 is formed with two cavities 213 spaced apart from each other, and two flanges 214 proximate to the cavities 213, respectively.

B) Mounting Counterweight Units:

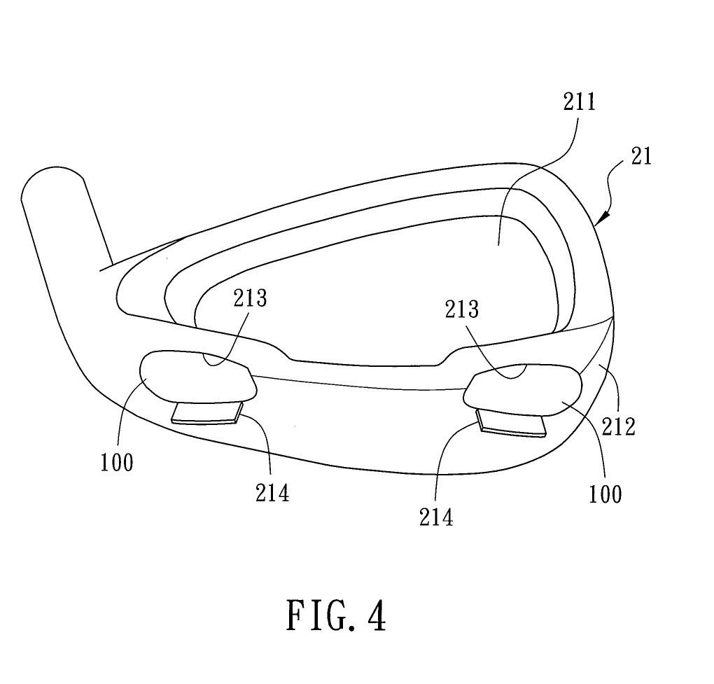

Referring to FIG. 4, two counterweight units 100 are mounted in the cavities 213, respectively. The counterweight units 100 have contours corresponding to those of the cavities 213, respectively. The number of the counterweight units 100 and the positions of the corresponding cavities 213 can vary according to the specific weight-distribution requirement for a golf club head to be made.

C) Bending the Flanges:

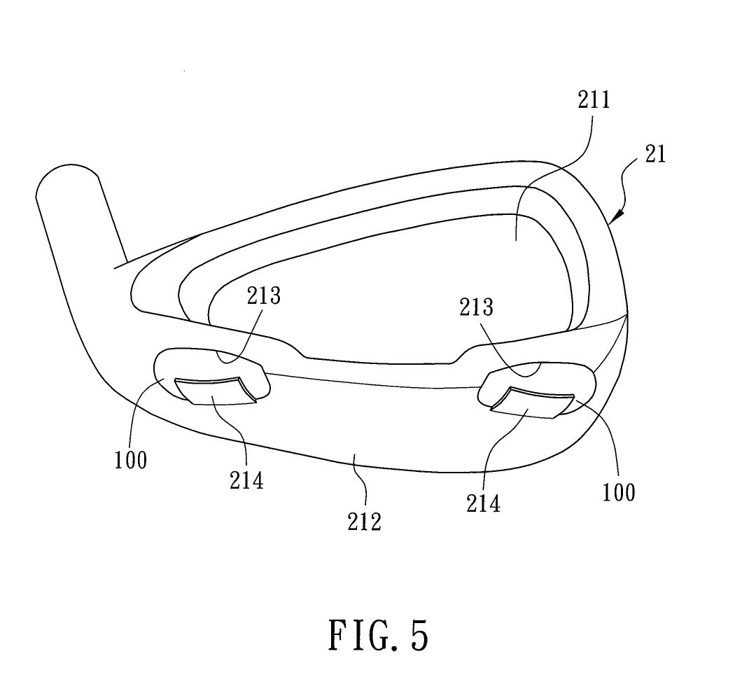

Referring to FIG. 5, the flanges 214 are bent toward the cavities 213 and are pressed against the counterweight units 100 via roller-pressing.

D) Joining:

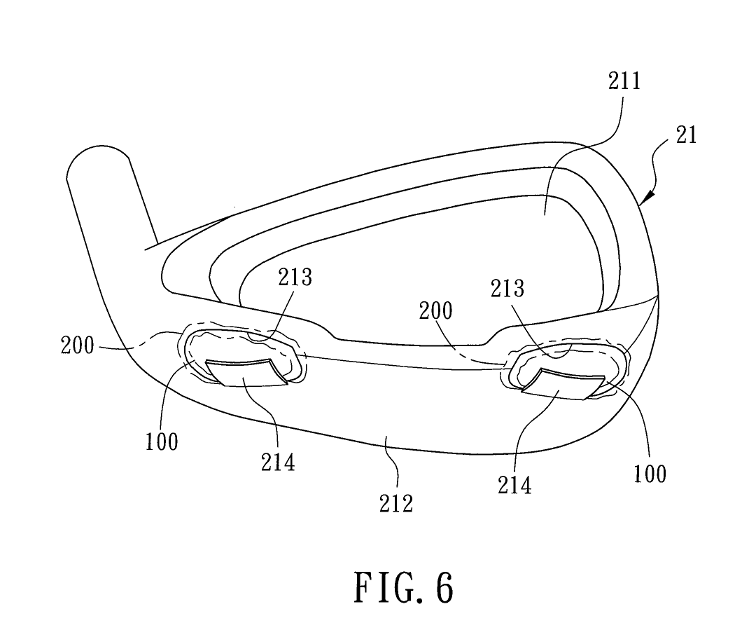

Referring to FIG. 6, the counterweight units 100 are joined to the head body 21 using a solder 200. The joining step is conducted by applying the solder 200 into a gap between each of the cavities 213 and a corresponding one of the counterweight units 100, and melting and penetrating the solder 200 into the gap by heating, thereby joining the counterweight units 100 to the head body 21 after cooling.

E) Polishing:

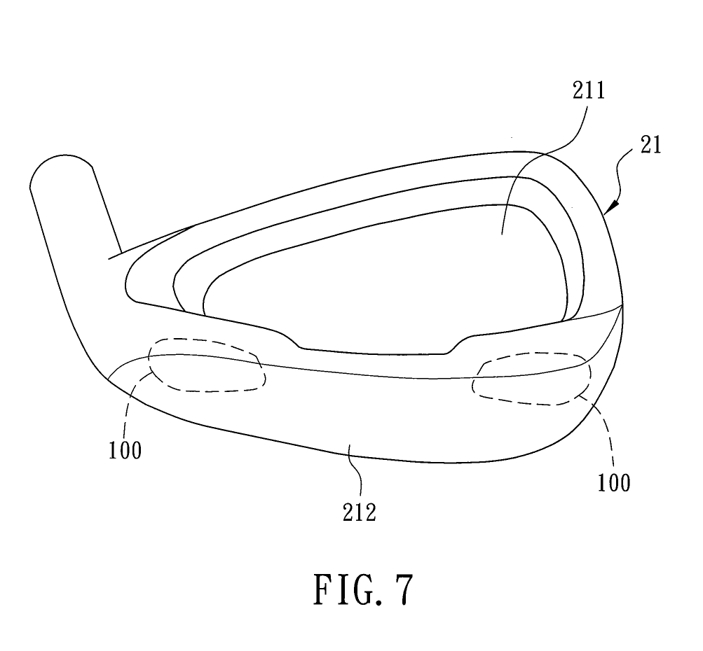

Referring to FIG. 7, the head body 21 and the counterweight units 100 are polished to remove excess of the flanges 214 and the solder 200 and to impart a smooth surface to the golf club head.

In view of the aforesaid, it is not necessary to use a fixture device in the present method of making a golf club head. Therefore, the present method is relatively flexible, and the production cost can be reduced by the present method.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method of making a golf club head, comprising the steps of:
preparing a head body formed with at least one cavity, and at least one flange protruding from the head body and proximate to the cavity;
mounting a counterweight unit in the cavity;
bending the flange toward the cavity and pressing the flange against the counterweight unit;
joining the counterweight unit to the head body using a solder; and
polishing the head body and the counterweight unit to remove excess of the flange and the solder.

2. The method as claimed in claim 1, wherein the head body is formed with two cavities spaced apart from each other and two flanges proximate to the cavities, respectively.
